(19) United States
(12) Patent Application Publication
(10) Pub. No.: US 2010/0293833 A1
(43) Pub. Date: Nov. 25, 2010

(54) Fishing lure

(76) Inventor: Martin Dominic Bossone, III, North Royalton, OH (US)

Correspondence Address: Patrick J. Thomas, 22460 Calverton Rd., Shaker Heights, OH, 44122, US

(21) Appl. No.: 12/799,344

(22) Filed: Apr. 22, 2010

Related U.S. Application Data
(60) Provisional application No. 61/214,406, filed on Apr. 23, 2009.
(60) Provisional application No. 61/216,875, filed on May 22, 2009.

(51) Int. Cl. A01K 85/01; A01K 85/00; A01K 85/16

(52) U.S. Cl. 43/17.6; 43/42.31; 43/42.06; 43/42.32; 43/42; 43/42.35; 43/42.45; 43/42.37; 43/42.49; 43/42.19

(57) ABSTRACT

The invention claims a novel fishing lure comprising a segmented portion wherein the segmented portion is rigid. The invention also claims a novel wing feature comprising a rotating wing bar, a blade and a wing lock.

This application is filed within one year of and claims priority to Provisional Application Ser. No. 61/214,406 filed Apr. 23, 2009 and Provisional Application Ser. No. 61/216,875 filed May 22, 2009.

### FIELD OF THE INVENTION

The present invention is directed to a fishing lure. Angling, or fishing, refers to the catching of fish by means of hook and line and may be referred to as sport fishing or game fishing. The present invention may be applicable to any type of fishing, whether done for sport, commercial, personal or any use.

### BACKGROUND OF THE INVENTION

Fishing bait may be affixed to the end of a fishing line, which also contains a hook or a snag, needed to trap, ensnare or catch fish. While live bait may be preferable, it can be costly, messy and unpleasant to work with. In many conditions, man-made bait may be preferred. It is well known in the field of fishing that man-made bait, or a lure, used to attract fish, is more beneficial and advantageous when the lure has life-like, or organic, qualities. In order to achieve this, various non-organic lures have been designed to mimic organic bait by creating man-made worms, fish, eggs, insects, reptiles, amphibians and other water-born animals as well as plants and fungi. Further, lures have been designed to exhibit organic qualities, including various colors, shapes, lights, sounds, scents and movements. Movements have been a particularly challenging feature. One type of movement is body movement. In order to give the lure the features of body movement, the combination of the angler's efforts to pull the lure and hook across or through water in conjunction with features on the lure itself may result in the appearance of the lure “swimming” across or through the water. This has been accomplished in the prior art through symmetrical and partially asymmetrical contouring of the front and back of a tube-shaped or minnow shaped fish. Another way that this has been accomplished is by the addition of a “bill,” or flat, downward piece in the “front” of the lure, so that the that the forward and/or forward and sideways movement implemented on the fishing line by the angler causes the lure to “dive” into the water while the opposing floatation force ultimately yields an up and downward action that mimics swimming. Another way that movement has been accomplished is by portioning the lure into two or more segments attached by a pivoting or rotating connector so that the angler's forward and/or forward and sideways movement implemented on the fishing line gives the appearance that the lure is sculling and mimics the forward propulsion accomplished by live prey through the contraction and relaxation of muscle blocks. Another way that movement has been accomplished is by the positioning of various fins that cause the lure to move in particular directions. Yet another way that movement has been accomplished is by the addition of one or more loosely connected spinners, skirts, tails or fins that spin, waive or shake as a result of the friction of the water imparted by the angler's forward and/or forward and sideways movements imparted on the line. Finally electronic fishing lure have become popular because built in mechanisms can cause the lure to behave in a desired manner. Despite the variations employed in the prior art, the life-like qualities of organic prey sought by fish have not suitably been achieved and disadvantages of prior art still exist.

### SUMMARY OF THE INVENTION

In view of the foregoing described and other obvious disadvantages inherent in the known types of fishing lures presently existing in the prior art, the present invention provides a new fishing lure that better mimics the swimming action of prey and is substantially more attractive to fish. The present invention describes and claims, among other features, a fishing lure with a rigid, segmented body, such that in conjunction with other prior features, the present invention describes a drastically improved fishing lure that yields substantially greater results. The inventor has discovered that the rigid segmented lure obtains increased roll, yaw and pitch, likely due to the change in forces applied on the segmented lure by the water as it moves. Specifically, the inventor has found that the greatly increased roll of the segmented lure results in accentuation of other features that may be present on the lure, such as an eye, or fin, or tail. The inventor has discovered that this improved feature greatly improves the attack rate by fish.

The general purpose of the present invention, which will be described hereafter in greater detail, is to provide a new fishing lure and method for employing the same which has many of the advantages of existing fishing lures mentioned above. It also includes novel features that result in a new fishing lure that is not anticipated, rendered obvious, suggested, or even implied by any of the prior art related to fishing lures, either alone or in any combination thereof.

It is inherent in the present invention that features in the prior art may be combined with the present invention. The present invention provides for a fishing lure wherein the body of the non-organic bait comprises a segmented portion of the body of the lure. This feature greatly enhances the movement of the lure through the water and results in a more accurate mimicking of a live organic animal by increasing the roll, pitch and yaw of the lure as it moves through the water. The present invention also provides for a parallel mounted appendage, such as a wing, that may spins in the forward direction of the lure movement. These features are novel and not present in the prior art. When employed individually or collectively each of these embodiments greatly enhances the productivity of a fishing lure.

The more important features of the invention have been broadly outlined in order that the detailed description thereof which follows may be better understood and so that the present contribution to an improvement in the art may be better appreciated. There are additional features of the invention that will be described hereinafter and which will form the subject matter of the claims appended hereto.

With respect to the claims herein, and before describing at least one preferred embodiment of the invention in detail, it is to be understood that the invention is not to be limited in its application to the details of construction and to the arrangements of the components which are set forth in the following description or illustrated in the drawings. The invention is capable of being created in other embodiments and of being practiced and carried out in various ways. Also, it is to be understood that the phraseology and terminology employed here are for the purpose of description and should not be regarded as limiting.

As such, those skilled in the art will appreciate that the conception upon which this disclosure is based, may readily be utilized as a basis for the designing of other forms, structures, methods, and systems for carrying out the several purposes of the present invention. It is important, therefore, that the claims be regarded as including such equivalent constructions in so far as those constructions do not depart from the spirit and scope of the present invention.

Further, the purpose of the appended abstract is to enable the United States Patent and Trademark Office, and the public generally, and especially designers, manufacturers, and practitioners of the art who are not familiar with the patent and legal terms or phraseology, to determine quickly from cursory inspection the nature and essence of the technical disclosure of the application. The abstract is neither intended to define the invention of the specification, which is measured by the claims, nor is it intended to be limiting as to the scope of the invention in any way.

### BRIEF DESCRIPTION OF THE DRAWINGS

FIG. 1 depicts an example of a three dimensional lure that is segmented.

FIG. 2 depicts an example of the surface of a segmented lure.

FIG. 3 depicts yet another example of the surface of a segmented lure.

FIG. 4 depicts yet another example of the surface of a segmented lure.

FIG. 5 depicts an example of a partially segmented three dimensional lure.

FIG. 6 depicts an example of a segmented lure with orientation and depicts additional features that may be added to the lure.

FIG. 7 depicts an example of a separate lure portion wherein other features are attached by a connector.

FIG. 8 depicts an example of a rotating and spinning wing bar.

### DETAILED DESCRIPTION OF THE PREFERRED EMBODIMENTS

An artificial, or non-organic, or man-made fishing lure is a preferable substitute for live or organic bait. Bait can be an essential component that is affixed in conjunction with a hook to the end of a fishing line so that a fisherman or an angler may snare, capture, hook or catch a fish. A non-organic artificial lure is often preferred to organic bait because it is more cost-effective, reusable, cleaner, and, in some instances, more effective than live bait. A lure is an object, often designed to resemble fish prey, equipped with one or many hooks or sharp objects used to ensnare or catch fish. The invention described herein may be applicable to any form of fishing, including that intended for commercial, personal, leisure, sport or hunting purposes. The intended purpose for fishing may be to obtain fish for consumption, competition, leisure or any conceivable purpose. The term fish as used herein generally describes those animals of classes Chondrichthyes and Osteichthyes but also includes any water-borne species that may be trapped, ensnared, hooked or caught using the invention.

Typically, an angler or fisherman affixes a lure with (1) hooks for trapping the fish and (2) a fishing line in order to pull or drag the lure through the water. The fishing line is usually attached to a fishing pole or fishing rod, but it may be attached to any article that allows for the lure's retrieval from the water. When an angler casts the lure into water, he may then retrieve the lure by pulling, reeling, or retrieving the lure by pulling the line toward him through the water either while the lure floats upon the water, is submerged under the surface of the water, or a combination of both. A variety of techniques may be used for retrieving the lure in the present invention. First, a lure may be allowed to float in calm or moving waters. Or the lure may be pulled through the water in a uniform direction of desired speed. Often, an angler will make lateral motions upon the lure by moving the fishing pole side to side while the line is being retrieved resulting in a forward zigzag pattern of the lure. Often these techniques may be employed in one smooth event or in a series of events so that the lure mimics some aquatic life form and become attractive to a fish. A lure may also be affixed to the line whereby it is drawn through the water in a process known as trolling. In any of these conditions, the lure exhibits properties of yawing, pitching and rolling, whereby yaw is the lateral or sideways motion (or rotation about the vertical axis), pitch is the vertical motion (or rotation about the left-right longitudinal axis), and roll is the rotation about the front-back longitudinal axis. The inventor has discovered a method that effects each of these directional movements, especially the degree of left and right roll. As a result, the lure may have a greater mimic of a live piece of bait and is consequently more attractive to a fish. The inventor has discovered a significant increase in fish attack of the lure described and claimed herein when used with traditional fishing techniques. It is anticipated that any applicable fishing technique with the lure will be advantageous.

In one embodiment of the invention, the lure is segmented. The segmented lure may be comprised of two or more portions or units that adjoin to form the lure. The units may be of one or more repeating units that adjoin to form the lure. The units may be of the same shape or of different shapes. The sizes of the units may be the same size or may be different sizes. The lure may be comprised of entirely separate units connected to each other in a linear fashion to form a segmented lure. The lure may also be linear, single piece of material with periodic or random grooves placed into the lure to give the appearance or effect of a segmented lure. The lure may also be a combination of separate units adjoined to each other and then ultimately joined to a material with periodic or random grooves that may also be considered segmented, such that the lure is segmented. The segmented lure may be comprised of repeating identical units or units that have no relation to other units in the lure. The units may be general two- or three dimensional geometric shapes, such as, for example, circles or ellipses, or, for example, partial circles or partial ellipses. The units may mimic shapes found in animal body parts, such as, for example, a head, body, thorax, abdomen or wing, or may mimic partial animal body parts, such as, for example, a portion of a thorax or abdomen. Ideally, the lure is a series of adjoined segmented units that form a linear lure to mimic a natural animal, but the segments may be adjoined in alternative fashioned to obtain the same or similar success of a linear lure. The lure may be one solid piece or two or more pieces connected together. The size of the lure may be any size. The inventor has had success in catching fish that are the same size as the lure itself. Typically a lure that is 10 cm in length may be useful for catching fish from 10 cm up to 100 cm. However, the lure may be decreased or increased to any size in order to be attractive to smaller or larger fish as desired. The segments of a lure may be of the same size or of different sizes. shapes. Ideally, a lure is segmented by inserting spatial grooves, wedges, cuts, sections or spaces into a single portion of the lure to achieve segmentation. However, individual, separate units may be adjoined or affixed to each other in order to achieve a segmented lure. The entire lure may be segmented or a portion of the lure may be segmented. Ideally, the lure is rigid, such as with a piece of wood or hard plastic, but it may exhibit some flexibility, as with softer plastic or rubber. As the rigidity of the lure is increased, the effect of the roll is greater, likely due to the required changing water forces upon the lure as it is propelled through the water. A rigid, segmented portion may also be used in conjunction with highly flexibly or elastic portions in order to achieve the same effect.

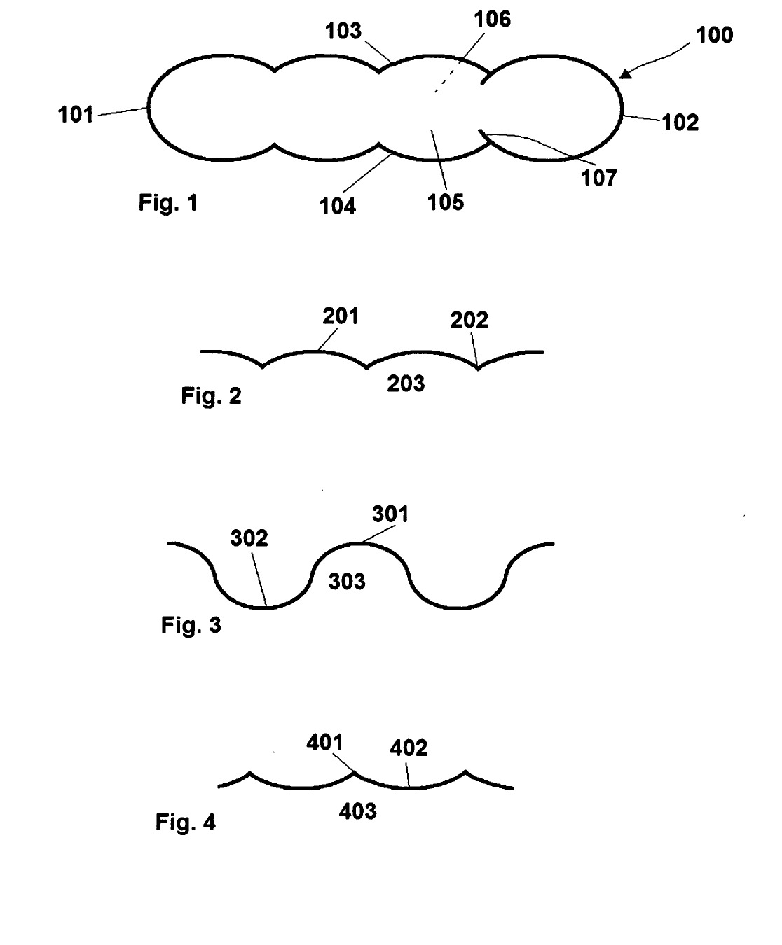

FIG. 1 is a depiction of a segmented lure 100 that is contemplated by the present invention. In FIG. 1, the lure is comprised of portions or units that make it segmented. The lure is three-dimensional, having a forward side 101 which may be represented by the left side of the figure. The lure also has a backward side 102, which is represented by the right side of the figure. The lure also has a top side 103, which is represented by the top side of the figure. The lure also has a bottom side 104, which is represented by the bottom of the figure. The lure also has a left side 105 which may be represented by the side of the figure extending out of the page. The lure also has a right side 106, which is represented by the side of the figure extending into the page. The lure in FIG. 1 is rotationally symmetrical in any direction, and use of the lure by rotating it in any direction may yield the advantageous effect. It is contemplated by the present invention that one or more segments may be firmly attached to each other or they may rotate against one-another in a joint-like ball and socket fashion as is depicted in FIG. 1 at 107.

Segmentation is achieved in nature by a series of crests and troughs as indicated in FIG. 2, ideally wherein the outward crests have a soft outward concave region 201 and an inward trough that is brief, sharp and wedge-like 202. 203 designates the inside, or the lure itself. As depicted in FIG. 3, the crests and troughs may also be sinusoidal so that both crests 301 and troughs 302 are smooth curves. 303 designates the inside, or the lure itself. As depicted in FIG. 4, the crests and troughs may also have brief, sharp outward crests 401 and soft inward troughs 402. 403 designates the inside, or the lure itself. It should be noted that any combination of groves, wedges, cuts or spaces placed within one segmented area or within the entire lure, in light of the possible combinations among FIGS. 2, 3 and 4 are contemplated by the invention and will yield a highly successful lure.

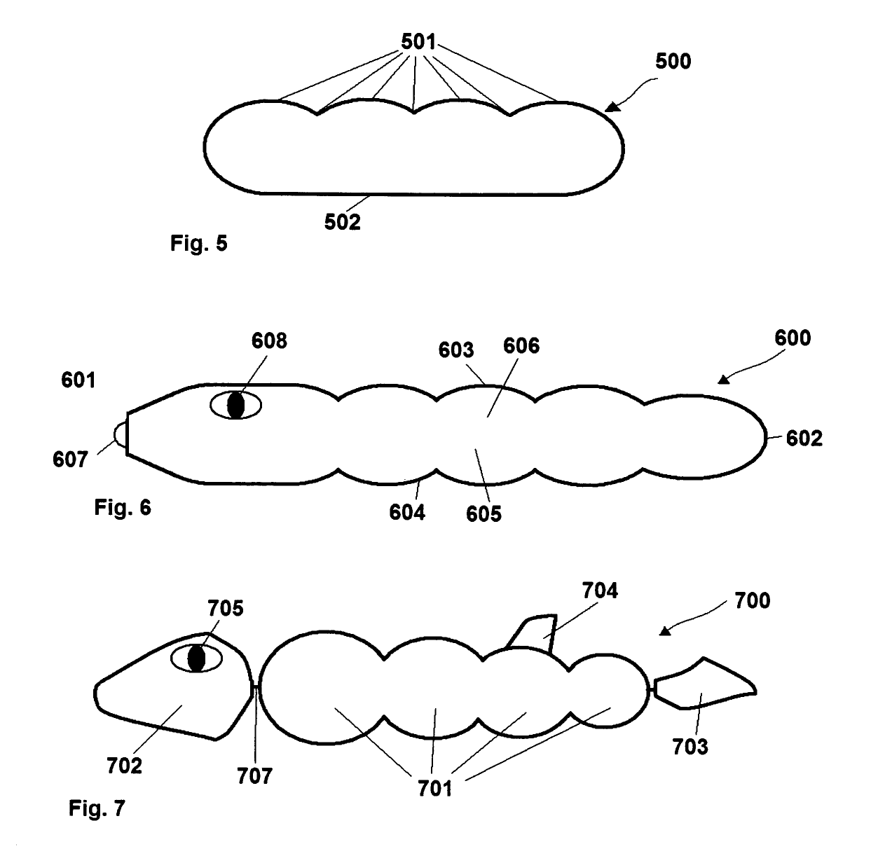

The lure need not be symmetrical in any direction in order to achieve the maximized effect of the invention. As depicted by FIG. 5, it is contemplated that only a portion 501 of the segmented lure 500 may be segmented while another portion 502 is not segmented and the desired advantageous effect of the invention will be realized.

Ideally, the lure is attached to the string or fishing line at the front or anterior position so that the lure mimics a forward moving animal when tension is applied to the anterior position. Application of a fishing line will allow the angler to draw the lure toward him with forward and or sideways movements to give the lure the effect of swimming. FIG. 6 is a depiction or a segmented lure 600 that is contemplated by the present invention. The lure 600 is three-dimensional, having a front or anterior position 601. The lure also has a back end or anterior position 602. The lure also has a top side, which is represented by the top side or dorsal position 603. The lure also has a bottom side, which is represented by the bottom side or ventral position 604. The lure also has a left side, which is represented by the left lateral side, or the portion that extends out of the page 605. The lure also has a right side, which is represented by the right lateral side, or the portion that extends into the page 606. The lure also may have a connector 607 whereby the fishing line connects to the anterior position in order to move it or tug it in a forward-moving fashion. The lure may also have an anatomical feature such as an eye 608 or other identifiable anatomic feature placed upon the lure. The eye or other feature may be raised or flat against the lure depending on the desired effect sought.

FIG. 7 depicts a representative segmented lure 700 that has varied segment sizes 701 within a segmented portion of a lure as well as additional features that may be affixed to the segmented portion. The segmented portion also has a head 702 affixed to it at the anterior position by a connector 707. It also has a separate tail or fin 703 connected to the posterior portion of the segmented portion. The head also has an eye 705 which may be applied to the head in any manner. FIG. 7 represents the limitless possibilities of variations and additions that may be applied to a segmented portion to produce a segmented lure described herein.

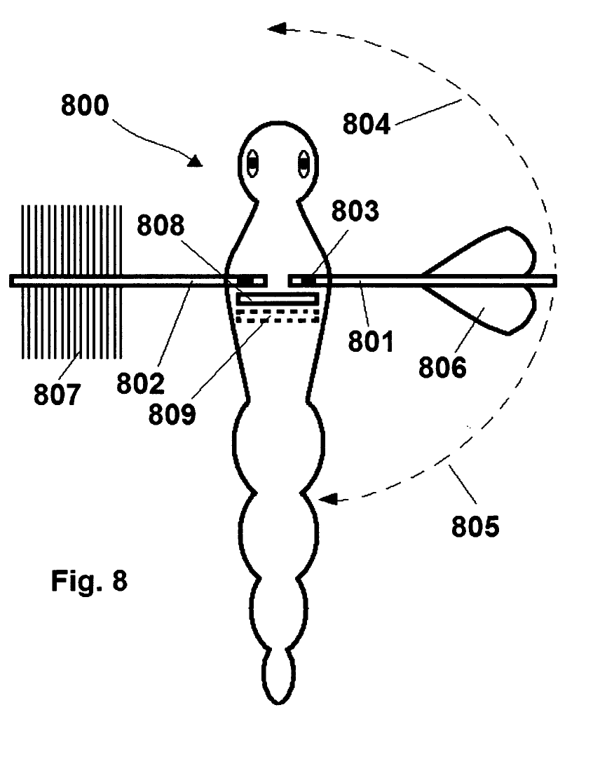

In yet another embodiment of the invention, the lure is affixed with wings. The inventor has created a type of wing that that has novel features as depicted in FIG. 8. The birds-eye or dorsal view of the segmented lure 800 has a wing bar 801, (or pair of wing bars 801 and 802 as would be desirable), that is depicted as parallel and extends laterally or outward from the body of the lure. The wing bar 801 is mounted 803 at any desirable place, but ideally on the dorsal part of the lure, in such a way that the wing bar is capable of rotating 804 from the anterior position to the posterior position 805. Any conceivable method for mounting the wing bar so that it rotates from the anterior to the posterior position would be useful, including a pin, a cotter pin, a hinge, a joint, spring, or the like. It is a feature of the invention that in addition to the anterior/posterior rotation, the wings that they will spin in a forward or backward manner. In order to accomplish this a blade 806 or series of blades are mounted on the wing bar. The blade is any useful protrusion, such as leaves, propellers, vanes, hair 807, fur, tassels, trimming or any item that will protrude outward from the wing bar as it spins. If blades are employed, ideally three or four blades are used but more or less than this number will also accomplish the spinning feature. The blade may be flat or curved, and may be of any desirable shape. The blade, or any item that is used to accomplish the spin feature, may be a separate unit affixed to the wing bar or it may be produced so that the blade and wing bar are a single unit. It is yet another feature of the invention that a wing lock 808 is employed at some position posterior to the mounted wing bar to prevent the wing bar from rotating past a certain position posterior or anterior (or both) position. The wing lock may be of any form and may be artistically concealed, such that it prevents the wing bar from moving past a certain position. Ideally, the wing lock is placed in such a position that it prevents the wing bar from rotating any further posteriorally than completely perpendicular, or ninety degrees. As a result, when the lure is being retrieved, the wing bar and blades will spin forward in the direction of the retrieval and give the appearance that the lure is swimming forward. It may be conceivable to place the wing lock more posterior 809 which will allow the wing to spin at a position greater than ninety degrees. While it is believed that the force of lure retrieval or forward movement of the lure in conjunction with the friction of the water is ideal to accomplish the spin, it is also a feature of the invention that the wing may spin as a result of electrical means, such as by a battery, a computer or the like. While this rotating and spinning wing is a novel type of wing, any suitable type of wing may be affixed to the segmented lure.

The wing bar, blade (or substitute), mounting, and wing lock may be comprised of any known materials suitable for making the invention. The items may be made of any color or feature described within this specification or that is obvious to achieve the result of the rotating and spinning wings. It is further an object of the invention that, if desired, the wing bars may be mounted at any position on the wing in order to achieve the desired rotation and/or spin.

Ideally, the segmented portion of the lure is rigid. A rigid lure is one that exhibits little or no flexibility or bending. A rigid lure allows for greater control by the angler of the movements of the lure. While a rigid, segmented lure is preferred, some elasticity, bending, docility, extensibility, flaccidity or suppleness may be employed to make the lure effective. The rigidity of the segmented portion of the lure is a novel feature of the invention because the forces exerted on a rigid lure likely give rise to the increased roll, yaw and pitch of the entire lure, thereby maximizing its attractiveness to fish.

The Lure may be comprised of any material that is suitable for production of the lure or for making the lure effective. The lure may be comprised of plastics, including thermosets or thermoresins or thermosettings, for example, including acetal, acrylic, acrylonitrile-butadiene-styrene, alkyds, cellulosics, coumarone-indene, diallyl phthalate, epoxy, fluoropolymer, latex, malamine-formaldehyde, nitrile resins, nylon, petroleum resins, phenolic, polyamide-imide, polyarylates, polybutylene, polycarbonate, polyethylene, polyimides, petroleum resins, phenolic, polyamide-imide, polyarylates, polybutylene, polycarbonate, polyethylene, polyimides, polymethyl acrylate, polyphenylene oxide, polyphenylene sulfide, polypropylene, polytetrafluoroethylene, polystyrene, polyurethanes, polyvinyl acetate or other vinyls, polyvinyl chloride, styrene acrylonitrile, styrene butadiene latexes or other styrene copolymers, sulfone polymers, thermoplastic polyster, unsaturated polyester, urea-formaldehyde, or any suitable plastic or polymer, or any combination of such plastics or polymers. The lure may comprised of wood including but not limited to natural or synthetic forms of combinations of cellulose, hemicelluloses, lignin or other material and may be a soft wood or hard wood such as, for example, cedar, balsa, oak, chestnut, ash, cherry, buckeye, poplar, willow, black locust, catalpa, elm, hickory, mulberry, or any type of natural or synthetic wood or combination suitable to make the invention. The lure may be comprised of metal such as, for example, aluminum, titanium, chromium, manganese, iron, copper, zinc, nickel, silver, palladium, platinum, gold, or alloys such as of iron (steel, stainless steel, cast iron, tool steel, and alloy steel), copper, aluminum, titanium, copper and magnesium or any suitable metal or alloy or combination thereof. The lure may be comprised of glass, such as for example, silicon dioxide, soda-lime glass, borosilicate glass, acrylic glass, sugar glass, muscovy-glass, or any type of glass suitable for making the lure. The lure may also be comprised of rubber, such as, for example, acrylic rubber butadiene rubber, butyl rubber chlorobutyl rubber, chlorinated polyethylene rubber, chlorosulphonated polyethylene rubber, epichlorhydrin ethylene acrylic rubber, ethylene propylene rubber, fluoroelastomers, hydrogenated nitrile rubber, isoprene rubber, natural rubber, nitrile rubber, perfluoro elastomers, polychloroprene rubber, polynorbornene rubber, polysulphide rubber, polyurethane rubber, silicone rubber, fluorosilicone rubber, styrene butadiene rubber, tetra-flouroethylene/propylene, or any combination thereof, or any rubber, synthetic or natural that is suitable for the invention. The lure may also be comprised of stone (such as marble and other minerals), hair, fur, cloth, fiber, paper or any material or combination of materials suitable for making the lure.

The lure may be comprised of a substance or substances described above that may be coated with a particular material. A coating may be applied to the lure in order to protect or enhance, for example, the appearance, adhesion, wettability, corrosion resistance, wear resistance, scratch resistance, chemical vulnerability, electrical conductivity or resistance, dielectrical, temperature control, abrasion, or solubility of the lure. It is anticipated that certain coatings may be desirable for any number of conditions. Coatings may be, for example, of any color, including being opaque, translucent, transparent reflective anti-reflective, refractive, polarized, ultraviolet, infared, or optical, and may have biological or chemical effects such as anti-fouling (to resist slime buildup) or organic (as in an attractive food source such as salts, lipids, carbohydrates, proteins or pharmaceutical agents). Coatings may be for applied to provide adhesiveness, tackiness or lubrication. Coatings may include such coatings, for example as paint, enamel, urethane, acrylic, epoxy, hybrid, latex, emulsion, metallic, silicone and polytetrafluoroethylene coatings and may employ such compounds as Teflon®, Teflon-S®, Teflon PFA®, Teflon TFE®, Tefzel/ETFE® & Teflon FEP®, Krytox®, Vydax®, Silverstone®, Xylan®, Dykor®, Castall®, Halar®, Emralon®, Kynar®, Electrofilm®, Everlube®. Coatings may be of any desired thickness, which may or may not be uniform across the surface of the lure. Coatings may be applied as gasses, liquids or solids. Coatings may include labels, decals, shrink wrap, liners, adhesives, or any material useful in applying and advantageous coating. Coating may be used in combination of one another or separately or in combination in various parts of the lure.

The surface of the segmented lure may be smooth or textured, including, for example, such textures as matte, glossy, scaled, rough, etched, porous and the like. The surface may further have natural features such as naturally occurring anatomic features, including, for example, a mouth, tongue, teeth, fangs, labrum, labium, bill, beak, whiskers, scales, eyes, compound eyes, olfactory bulb, ocelli, gills, ears, wings, antennae, antennules, chiliped, necks, arms, legs, claws, nails, fins, tails, telson, genitals, gonads, shells, umbrella, tentacles, canals, clitellum, thoraxes or abdomens or any other advantageous biological feature to render to the lure life-like.

The lure may be solid or hollow, in whole or in part. It may be desirable to create a lure, or a portion of the lure, that is hollow, for example, as an industrial advantage (such as for preparation as in the employment of injection molding preparation) or for weight and floatation qualities desired in the lure, or for the insertion of objects (such as, for example, electrical or mechanical components). It may be desire to create a lure, or a portion of a lure, that is solid, for example, as an industrial advantage (such as in the employment of saw-cutting machines or for carving) or for weight and flotation qualities.

A segmented lure may be comprised of the addition to or deletions of portions of the lure that increase or decrease the weight and or bouyancy of the lure. Weights may be affixed to the lure, for example, on the back end, middle, or front end of the lure to cause to lure to submerge in whole or in part under the surface of the water. Floats, and or floats and weights, may also be affixed to a lure in order to achieve a certain depth at which a lure will “swim.”

The lure may be comprised of any color or combination of colors that is or are desirable. For example, it may be desirable to apply colorings to body portions of the lure that are similar to those found in nature, or that are contrasting with one another and are therefore attractive to fish. The inventor has found that affixing or applying “eyes” to each side of the anterior portion of the fish, wherein the eyes are bright yellows, oranges and reds, accentuated by a black or dark outline are very attractive to fish when the roll angle of the fish is maximized (e.g. the eye of the lure rolls from a horizontal position to a vertical position and results in an attack of the lure by a fish).

The lure may be affixed with a crank or bill, which when applied to the front of the lure, causes the lure to dive underneath the surface of the water when the lure is retrieved. A forceful retrieval of a lure affixed with a crank results in a lure swimming submerged in the water. Application of sideways movements by the angler on the lure will further cause the lure to roll as it “swims” submerged. More than one crank placed on other parts of the lure may be desirable.

The lure may be scented or scents may be applied to a lure to make it more attractive. Scents may include any substance that emits odor molecules that may be attractive to fish, such as spices, fish, fruits, vegetables, meat, cheese, neutralizer or any natural or natural or synthetic item that emits an odor.

The lure may be affixed with an item or material that generates sound or uses sound devices. One common method to generate sound is to fill a hollow portion of a lure with pellets or beads that shake, rattle or click when the lure is pulled. Other mechanism that provide sounds are spring action mechanisms, electronic devices, spinners, or computers. Any method capable of producing sound is anticipated and may be desirable.

The lure may be affixed with an item or material that generates light. Light may be produced by a lure by hemoluminescence, bioluminescence, phosphorescence, cathodoluminescence, scintillation, electroluminescence, sonoluminescence, triboluminescence, or electronic means. A lure may be coated with a paint that luminesces, reflects, refracts or glows in order to produce light. Light may be of any color or duration, and may be of any intensity, frequency, wavelength, polarization or phase.

The segmented lure may also be affixed with one or more segmented pieces, For example, a segmented lure body may be affixed with a head and or tail, of any length, or two or more segmented portions may be affixed to each other.

The lure may be affixed with other items, such as spinners, or it may be used in conjunction with other lures, such as a spoon lure, a jig lure, a fly lure, a bucktail lure, or other wobbler, rattler, chopper or plug type lures.

It is an object of the present invention to affix a hook or series of hooks to the segmented lure. A hook may be any substance that is capable of catching a fish once the fish attacks the lure. Ideally a hook is made of metal or wire and has a sharp object for penetrating and therefore ensnaring the fish. Numerous types of hooks are known in the art and would be applicable to affix to the invention. A hook may be of any known type, such as a j-type hook, a Carlisle hook, a Limerick hook, an Aberdeen hook, a Kirby hook, an O'Shaungessy hook, a cam action hook, a sneak hook, a sproat hook, a breakpoint hook, or a specialty hook, such as a wide gap, pike, tone circle, barbless, bent down, hump shank, weedless or any type of hook used to trap the fish. The hook may be a single hook or may be affixed in conjunction with other hooks so that there are multiple hooks affixed to the lure. A hook may be affixed to the lure as a fixed hook or a swinging hook. A hook may be a barbed hook or a barbless hook. While a hook is the most popular item for trapping the fish, it is anticipated that any object that may stun or incapacitate a fish in conjunction with the lure may be suitable.

It is yet another embodiment of the present invention to affix a fishing line to the lure. A fishing line may be any line, such as a monofilament, nylon, Dacron, fluorocarbon or other polymer, or gel-spun and aramid fibers such as Spectra, Kevlar and Dyneema. The line may be fly-line, plastic or plastic-coated, cloth (such as silk, cotton or wool) metal or any material or combination of materials suitable for casting, placing or pulling a line on or through water. Fishing lines may be a single strand, braided, fused, tapered or spun. Lines may be of any length, diameter, thickness, sensitivity, knot strength, pressure strength or tensile strength, buoyancy, tangle resistance, texture or color.

What is claimed is:

1. A fishing lure comprising:
a segmented portion wherein the segmented portion is rigid.

2. The fishing lure of claim 1 wherein the fishing lure comprises a coating.

3. The fishing lure of claim 1 wherein the fishing lure comprises a textured surface.

4. The fishing lure of claim 1 wherein the fishing lure is solid in whole or in part.

5. The fishing lure of claim 1 wherein the fishing lure is hollow in whole or in part.

6. The fishing lure of claim 1 wherein the fishing lure comprises a weight.

7. The fishing lure of claim 1 wherein the fishing lure comprises a float.

8. The fishing lure of claim 1 wherein the fishing lure comprises coloration.

9. The fishing lure of claim 1 wherein the fishing lure comprises a bill.

10. The fishing lure of claim 1 wherein the fishing lure comprises a scented substance.

11. The fishing lure of claim 1 wherein the fishing lure comprises sound producing mechanism.

12. The fishing lure of claim 1 wherein the fishing lure comprises a mechanisms for producing light.

13. The fishing lure of claim 1 wherein the fishing lure comprises a series of segmented pieces.

14. The fishing lure of claim 1 wherein the fishing lure comprises a series of non-segmented pieces.

15. The fishing lure of claim 1 wherein the fishing lure comprises an additional anatomical feature.

16. The fishing lure of claim 1 wherein the fishing lure comprises a spinner.

17. The fishing lure of claim 1 wherein the fishing lure comprises a hook.

18. The fishing lure of claim 1 wherein the fishing lure comprises a fishing line.

19. A wing for a fishing lure comprising:
a rotating wing bar;
a blade; and
a wing lock.

20. A fishing lure comprising:
a segmented portion wherein the segmented portion is rigid;
a rotating wing bar;
a blade; and
a wing lock.
